(19) United States
(12) Patent Application Publication
(10) Pub. No.: US 2023/0162873 A1
(43) Pub. Date: May 25, 2023

(54) FUEL-CLADDING CHEMICAL INTERACTION RESISTANT NUCLEAR FUEL ELEMENTS AND METHODS FOR MANUFACTURING THE SAME

(71) Applicant: TerraPower, LLc, Bellevue, WA (US)

(72) Inventors: Micah J. Hackett, San Francisco, CA (US); Grant Helmreich, Knoxville, TN (US); Ryan N. Latta, Bellevue, WA (US); Gary Povirk, Nishkayuna, NY (US); Philip M. Schloss, Seattle, WA (US); James M. Vollmer, Kirkland, WA (US)

(21) Appl. No.: 17/882,323

(22) Filed: Aug. 5, 2022

Related U.S. Application Data
(63) Continuation of application No. 16/039,600, filed on Jul. 19, 2018, now abandoned.
(60) Provisional application No. 62/534,561, filed on Jul. 19, 2017.

(51) Int. Cl. G21C 3/20; G21C 21/02; G21C 21/14

(52) U.S. Cl. CPC G21C 3/20; G21C 21/02; G21C 21/14

(57) ABSTRACT

This disclosure describes fuel-cladding chemical interaction (FCCI) resistant nuclear fuel elements and their manufacturing techniques. The nuclear fuel elements include two or more layers of different materials (i.e., adjacent barriers are of different base materials) provided on a steel cladding to reduce the effects of FCCI between the cladding and the nuclear material. Depending on the embodiment, a layer may be the structural element (i.e., a layer thick enough to provide more than 50% of the strength of the overall component consisting of the cladding and the barriers) or may be more appropriately described as a liner or coating that is applied in some fashion to a surface of the structural component (e.g., to the cladding, or to a structural form of the fuel).

### CROSS REFERENCE TO RELATED APPLICATIONS

The present application claims the benefit of U.S. Provisional Pat. Application No. 62/534,561, titled “Fuel-Cladding Chemical Interaction Resistant Nuclear Fuel Elements And Methods For Manufacturing The Same”, filed Jul. 19, 2017, which application is hereby incorporated by reference.

### INTRODUCTION

When used in nuclear reactors, nuclear fuel is typically provided with cladding. The cladding may be provided to contain the fuel, to prevent the fuel from interacting with an external environment, and/or to prevent contamination of the coolant with fission products. For example, some nuclear fuels are chemically reactive with coolants or other materials that may otherwise come in contact with the nuclear fuel absent the cladding to act as a separator.

The cladding may take the form of a tube, sphere, or elongated prism-shaped vessel within which the fuel is contained. In either case, the fuel and cladding combinations are often referred to as a “fuel element”, “fuel rod”, or a “fuel pin”.

Fuel-cladding chemical interaction (FCCI) in metallic fuel systems refers to chemical reactions between the nuclear fuel and cladding components due to interdiffusion of one or more components. At higher burn-ups (>20%) interdiffusion of fuel and fission products into the cladding (or proximate to) or diffusion of cladding alloy elements into the fuel may degrade the strength of the fuel-cladding system by one of a number of mechanisms, such as chemical interaction, embrittlement, loss of strength, formation of unintended alloys, etc. Specifically, cladding components (iron and nickel) can migrate into the fuel forming low melting intermetallics with both uranium and plutonium, while the lanthanide fission products (neodymium, cerium, etc.) migrate outward into the cladding forming brittle intermetallics that are also prone to eutectic reactions.

This disclosure describes fuel-cladding chemical interaction (FCCI) resistant nuclear fuel elements and their manufacturing techniques. The nuclear fuel elements include two or more layers of different materials (i.e., adjacent barriers are of different base materials) provided on a steel cladding to reduce the effects of FCCI between the cladding and the nuclear material. Depending on the embodiment, a layer may be the structural element (i.e., a layer thick enough to provide more than 50% of the strength of the overall component consisting of the cladding and the barriers) or may be more appropriately described as a liner or coating that is applied in some fashion to a surface of the structural component (e.g., to the cladding, or to a structural form of the fuel).

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 illustrates a cut away view of a linear section of cladding equipped with a duplex FCCI barrier, or barrier-equipped cladding (BEC).

FIG. 2 illustrates a cross-section of a tubular embodiment of the BEC of FIG. 1.

FIG. 3 illustrates the BEC of FIG. 1 in contact with nuclear material, such as nuclear fuel.

FIG. 4 illustrates a cross-section of the tubular embodiment of the BEC of FIG. 2 with nuclear material contained within the tubular cladding provided with the duplex barrier.

FIG. 5 illustrates an embodiment of a method for selecting the barrier layer materials for an FCCI-resistant BEC and fuel element.

FIG. 6 illustrates at a high-level an embodiment of a method for manufacturing a FCCI-resistant fuel element.

FIG. 7 illustrates a cut away view of a linear section of cladding equipped with a triplex FCCI barrier.

FIG. 8 illustrates a cross-section of a tubular embodiment of the triplex BEC of FIG. 7.

FIG. 9 illustrates the triplex BEC of FIG. 7 in contact with nuclear material, such as nuclear fuel.

FIG. 10 illustrates a cross-section of the tubular embodiment of the triplex BEC of FIG. 8 with nuclear material contained within the tubular cladding provided with the triplex barrier.

FIG. 11a provides a partial illustration of a nuclear fuel assembly utilizing one or more of the fuel elements described above.

FIG. 11b provides a partial illustration of a fuel element in accordance with one embodiment.

### DETAILED DESCRIPTION

Before the FCCI-resistant nuclear fuel elements and their manufacturing methods are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a lithium hydroxide” is not to be taken as quantitatively or source limiting, reference to “a step” may include multiple steps, reference to “producing” or “products” of a reaction should not be taken to be all of the products of a reaction, and reference to “reacting” may include reference to one or more of such reaction steps. As such, the step of reacting can include multiple or repeated reactions of similar materials to produce identified reaction products.

This disclosure describes FCCI-resistant nuclear fuel elements and their manufacturing techniques. In the embodiments described below the nuclear fuel elements include two or more layers of different materials (i.e., adjacent barriers are of different base materials) provided on the steel cladding to reduce the effects of FCCI between the cladding and the nuclear material. Depending on the embodiment, a layer may be the structural element (i.e., a layer thick enough to provide more than 50% of the strength of the overall component consisting of the cladding and the barriers) or may be more appropriately described as a liner or coating that is applied in some fashion to a surface of the structural component (e.g., to the cladding, or to a structural form of the fuel). The layers will be referred to as “FCCI barriers” or, simply, “barriers” to highlight their function of preventing or reducing FCCI. The combination of the cladding and the FCCI barriers will be referred to as an FCCI barrier-equipped cladding (BEC). The combination of a BEC and any nuclear material contained by the BEC will be referred to as a fuel element.

In certain configurations of fuel and clad, such as steel cladding with uranium fuel, multiple FCCI barriers may be employed with each barrier interface being chosen to minimize any one or more of the above interactions. Additionally, barriers may be chosen such that interaction between barrier interfaces is minimized or impeded. In certain instances, a barrier may consist of an alloy with one or more constituent chemical elements which impede fuel cladding interactions. In other embodiments, alloys may be created such that concentrations of the constituents therein are gradated in a manner beneficial to impeding fuel cladding interactions.

Certain material combinations may not, however, be suitable for high burn-up. For example, some barrier materials may act to decarburize the steel when exposed to high temperatures over long periods of time. Other barrier materials perform well with steel but may diffuse into fuels such as uranium. This disclosure describes BECs and material selection processes that allow the creation of a fuel-side barrier that is stable with a fuel and surrounded by a second barrier stable with the clad. The barriers are also stable under irradiation with each other. The disclosed configurations of multiple FCCI barriers reduce the detrimental effects on the cladding.

For the purposes of this disclosure, for comparison purposes FCCI characteristics are determined by placing two materials in contact (attached to each other as discussed below) and held at 650° C. for 2 months in an inert atmosphere. Then the materials are inspected, such as by a scanning electron microscope, to determine the interdiffusion distance of one or more chemical elements (e.g., uranium, chromium, etc.) of interest into the different materials is determined. For example, a vanadium layer may be bonded to a uranium layer and held at 650° C. for 2 months, then inspected to determine how far the uranium has diffused into the vanadium. Many of the materials described herein are alloys containing multiple elements at different concentrations. When discussed below, unless it is specified otherwise, if a barrier or cladding material is said to have a better FCCI characteristic or better interdiffusion distance than a second material with respect to a third material, it means the interfusion distance of the base element (the element that has the highest percentage by weight in the alloy) of the first material is less than the interdiffusion distance of the base element of the second material in the third material. For example, it has been determined by the above method that ZrN has a better FCCI characteristic than vanadium with respect to HT9 steel, that is, ZrN was observed to have diffused a lesser distance into HT9 than vanadium diffused into HT9 after being held in contact for 2 months at 650° C. Thus, as described further below, ZrN is a good barrier material to be used between layers of vanadium and HT9, especially if the HT9 is the primary structural layer and the ZrN and vanadium are thin coatings.

Mechanically bonding the cladding-barriers-fuel system reduces the thermal resistance between the fuel and the cladding. This allows for traditional bonding materials to be omitted, such as liquid sodium. Unless otherwise specified the embodiments described herein have no bonding materials, e.g., no liquid sodium between layers. In an alternative embodiment, a metallurgical bond between layers of the BEC or fuel element may be formed, such as by pressing (e.g., hot, isostatic pressing), in order to reduce the thermal resistance between the fuel and cladding.

The following discussion recognizes that adjacent layers of a cladding may be connected by a mechanical bond, a metallurgical bond, or a diffusion bond and do not use a traditional bonding material. Mechanically bonded layers refer to layers in which the opposing surfaces are in physical contact. Parts connected by an interference fit are an example of mechanical bonded layers. While mechanically bonded layers may have some voids and may not be in perfect contact along the entire interface, the close proximity and physical contact allows for good thermal energy transfer between the layers. This can be used to remove the need for some sort of thermal transfer material between the layers. Metallurgically bonded layers have been further treated or otherwise processed to create a physical interface between the atoms on the surface of the two layers that is completely or substantially free of voids, resulting in a discrete interface between the layers. Metallurgical bonds have better thermal energy transfer than mechanical bonds due to the better contact, but still maintain a discrete interface in that there is substantially no interdiffusion of material between the layers. Interfaces created by hot isostatic pressing or vapor deposition are examples of layers connected by a metallurgical bond. Finally, layers may be diffusion bonded in which materials of the two layers are deliberately intermixed to create a zone of diffusion at the interface. In diffusion bonding, there is no clear interface between the two layers, but rather a zone in which the material gradually transitions from that of one layer into that of the other layer. Diffusion bonding changes the material properties within the zone of diffusion while mechanical and metallurgical bonds, on the other hand, do not substantially affect the properties of either layer and maintain a discrete interface between the two layers.

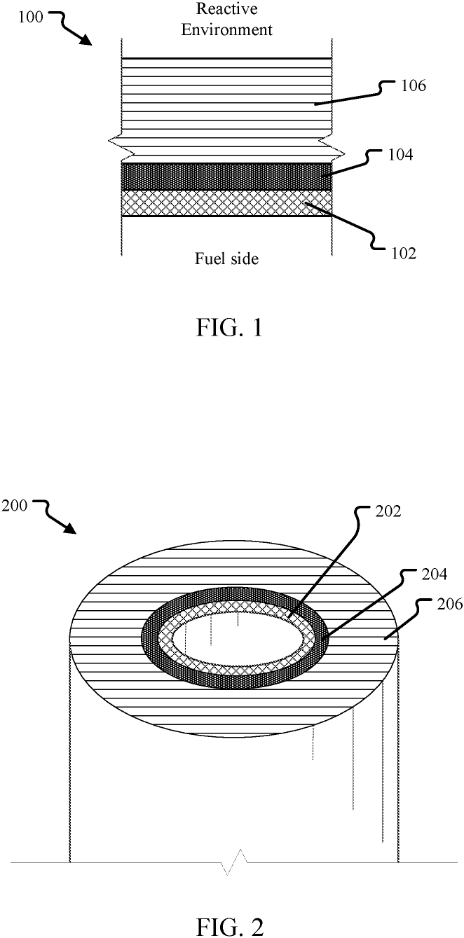

FIG. 1 illustrates a cut away view of a linear section, or “wall element”, of a BEC having a two-layer, or duplex, FCCI barrier. The BEC 100 may be part of any equipment, vessel, or component that separates nuclear fuel from an external environment. For example, the BEC 100 may be part of a wall of a tube, a rectangular prism, a cube, or any other shape of vessel or storage container for holding nuclear fuel. In an alternative embodiment, rather than being a section of wall of a container, the BEC may be the resulting layers on the surface of a solid nuclear fuel created by some deposition or other manufacturing technique as described below. When holding nuclear material, the BEC and nuclear material together will be referred to as a fuel element.

Regardless of the manufacturing technology used, the BEC 100 shown in FIG. 1 consists of two FCCI barriers 102, 104 of different base materials and a cladding 106. The layers of the BEC are each mechanically or metallurgically bonded to its adjacent layer(s) along the interface with that layer. For example, in a tubular embodiment such as FIG. 2 the layers of the BEC are mechanically or metallurgically bonded together along the perimeter interface between the layers. The first FCCI barrier 102 is referred to as the fuel-side barrier. The fuel-side barrier 102 separates the fuel, or the storage area where the fuel will be placed if the fuel has not been provided yet, from the second FCCI barrier 104. The second FCCI barrier 104, referred to as the cladding-side barrier, is between the fuel-side barrier 102 and the cladding 106. Thus, the fuel-side barrier 102 is a layer of material with one surface exposed to the fuel and the other surface exposed to the cladding-side barrier 104 while the cladding-side barrier 104 has a fuel-side barrier-facing surface and a surface connected to the cladding 106.

The cladding 106 is in contact with the external environment on one surface and the cladding-side barrier 104 on the opposite surface. Thus, the cladding 106 separates the duplex FCCI barriers from the external environment.

In an embodiment, the cladding 106 is the structural element of the BEC. That is, it provides the strength and rigidity to retain the shape of the fuel element when in use. In this embodiment, the barriers 102, 104 may be any thickness suitable to prevent FCCI. The thickness of the barriers 102, 104 may or may not be sufficient to impart much or any mechanical support to the structural integrity of the BEC. In an embodiment, a minimum fuel-side barrier thickness of 8 µm may be imposed. In some cases the barriers 102, 104 may be thin (e.g., less than 50 µm thick) and likened to a coating. In alternative embodiments, one or both of the barriers 102, 104 may be thicker (50 µm thick or greater) and considered a liner. In various embodiments, each barrier 102, 104, independently, may be from 1.0, 2.0, 2.5, 3.0, or 5.0 µm in thickness on the low end of a range of thicknesses and up to 3.0, 5.0, 7.5, 10, 15, 20, 25, 30, 40, 50, 75, 100 or even 150 µm in thickness as a bound to the upper end of the range.

The BEC 100 illustrated in FIG. 1 has a fuel-side barrier 102 of a material selected to reduce the effects of FCCI on both the properties of the cladding 106 and the stored fuel and also selected to reduce the effects of detrimental chemical interactions between the two barriers 102, 104.

As discussed below, the materials used for the cladding-side barrier and the fuel-side barrier are selected based on their compatibility with cladding material and nuclear material, respectively. That said, potentially suitable cladding-side barrier materials include refractory metals (e.g., Nb, Mo, Ta, W, or Re and alloys thereof) or metals with similar properties (e.g., Zr, V, Ti, Cr, Ru, Rh, Os, Ir, Sc, Fe, or Ni and alloys thereof); or refractory ceramics (TiN, ZrN, VN, TiC, ZrC, VC). Potentially suitable fuel-side barrier materials also include refractory metals (e.g., Nb, Mo, Ta, W, or Re and alloys thereof) or metals with similar properties (e.g., Zr, V, Ti, Cr, Ru, Rh, Os, Ir, Sc, or Ni and alloys thereof); or refractory ceramics (TiN, ZrN, VN, TiC, ZrC, VC). Although identical lists of material candidates are listed for each barrier layer, in an embodiment, all implementations will employ dissimilar base materials between the respective barrier layers. By ‘base material’ or ‘base chemical element’ it is meant the largest chemical element in the material by weight. For example, for an alloy that is more than 50% one chemical element, the base material is the chemical element that is more that 50% by weight of the alloy. For an elemental material, such as V, Zr, Mo, etc., the base material is that chemical element.

The BEC 100 illustrated in FIG. 1 has a cladding-side barrier 104 of a material having a different base material from that of the fuel-side barrier material (e.g., the cladding-side barrier may be a Ti alloy and the fuel-side barrier may be any material that is not primarily Ti, such as an alloy of Nb, Mo, Ta, W, Re, Zr, V, Cr, Ru, Rh, Os, Ir, Sc, Fe, TiN, ZrN, VN, TiC, ZrC, VC, or Ni). Again, the cladding-side barrier material is selected to reduce the effects of FCCI on the properties of the cladding 106 and the stored nuclear material, and is also selected to reduce the effects of detrimental chemical interactions between the two barriers 102, 104.

In an embodiment, with the original premise that a dual layer FCCI barrier will be required to satisfy the compatibility requirements of both the fuel and cladding, two different manufacturing methods may be best suited to apply the individual FCCI barriers. Relying on different manufacturing methods for the different barrier layers has the additional benefit of reducing the potential for single point failures, since the probability of defects aligning between both layers that are produced/applied via different methods should be exceedingly small. Due to the mobile and aggressive nature of the lanthanide fission products, this redundancy is particularly appealing since any defects in the FCCI barriers in high temperature (inner cladding temperature >550° C.) regions of the fuel elements are expected to lead to points of failure in metallic fuel systems with steel cladding.

The cladding 106 may be any suitable steel or known cladding material. Examples of suitable steels include a martensitic steel, a ferritic steel, an austenitic steel, stainless steels including aluminum-containing stainless steels, advanced steels such as FeCrAl alloys, HT9, oxide-dispersion strengthened steel, T91 steel, T92 steel, HT9 steel, 316 steel, 304 steel, an APMT (Fe-22 wt.%Cr-5.8 wt.%Al) and Alloy 33 (a mixture of iron, chromium, and nickel, nominally 32 wt.%Fe-33 wt.%Cr-31 wt.%Ni). The steel may have any type of microstructure. For example, in an embodiment substantially all the steel in the cladding 106 has at least one phase chosen from a tempered martensite phase, a ferrite phase, and an austenitic phase. In an embodiment, the steel is an HT9 steel or a modified version of HT9 steel.

Alternatively, the cladding 106 may be made of a material or alloy other than steel, such as molybdenum or a molybdenum alloy, zirconium or a zirconium alloy (e.g., any of the ZIRCALOY™ alloys such as Zircaloy-2 and Zircaloy-4), niobium or a niobium alloy, a zirconium-niobium alloys (e.g., M5 and ZIRLO), nickel or a nickel alloy (e.g., HASTELLOY™ N).

In one embodiment, the modified HT9 steel is 9.0-12.0 wt.% Cr; 0.001-2.5 wt.% W; 0.001-2.0 wt.% Mo; 0.001-0.5 wt.% Si; up to 0.5 wt.% Ti; up to 0.5 wt.% Zr; up to 0.5 wt.% V; up to 0.5 wt.% Nb; up to 0.3 wt.% Ta; up to 0.1 wt.% N; up to 0.3 wt.% C; and up to 0.01 wt.% B; with the balance being Fe and other chemical elements, wherein the steel includes not greater than 0.15 wt.% of each of these other elements, and wherein the total of these other elements does not exceed 0.35 wt.%. In other embodiments, the steel may have a narrower range of Si from 0.1 to 0.3 wt.%. The steel of the steel layer 104 may include one or more of carbide precipitates of Ti, Zr, V, Nb, Ta or B, nitride precipitates of Ti, Zr, V, Nb, or Ta, and/or carbo-nitride precipitates of Ti, Zr, V, Nb, or Ta.

In an embodiment, the layers 102, 104, 106 of a completed BEC will be attached without a gap or space between them. As discussed in greater detail below, this will be the result of either a mechanical attachment process (e.g., pilgering or press fitting) or a deposition process.

FIG. 2 illustrates a tubular embodiment of the BEC of FIG. 1. In the embodiment shown, the wall element 200 is in the form of a tube with an interior surface and an exterior surface, the fuel-side barrier 202 forming the interior surface of the tube and the cladding 206 of steel forming the exterior surface of the tube. Sandwiched between the fuel-side barrier 202 and cladding 206 is the cladding-side barrier 204. The fuel storage region is in the center region of the tube. Fuel, when placed within the tube, will be protected from the reactive external environment at the same time the cladding 206 is separated from the fuel.

The general term wall element is used herein to acknowledge that a tube, prism or other shape of container may have multiple different walls or sections of a wall, not all of which are a BEC. Embodiments of fuel elements include those that have one or more wall elements that are constructed of materials that are not the BEC 100 as illustrated in FIG. 1 as well as wall elements of the BEC 100. For example, a tube may have a cylindrical wall element of the BEC 100 described in FIG. 2 but have end caps of a different construction. Likewise, a polygonal construction, e.g., a rectangular (a box) or hexagonal prism-shaped fuel container, may have sidewalls and a bottom wall constructed as shown in FIG. 1, but a top of different construction.

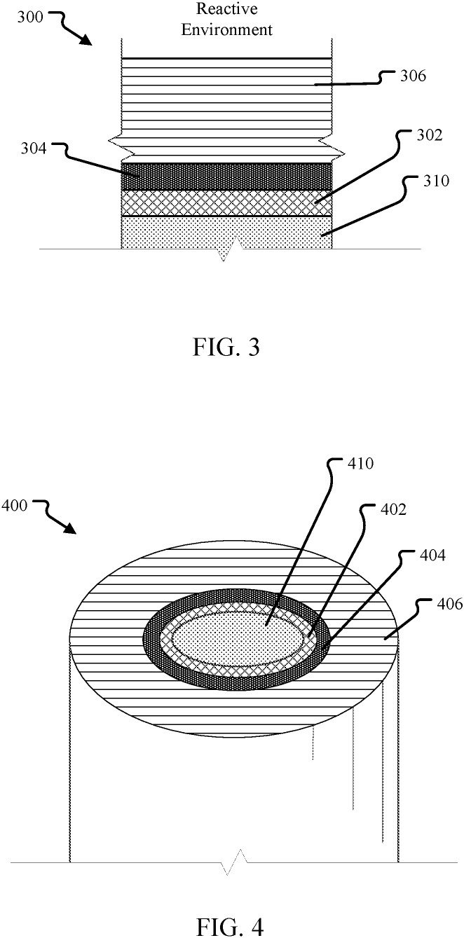

FIG. 3 illustrates the wall element of FIG. 1, but this time as a fuel element 300 with nuclear material 310, including but not limited to nuclear fuel, in contact with the fuel-side barrier 302. The fuel-side barrier 302 is separated from the cladding 306 by the cladding-side barrier 304. The barriers 302, 304, again, may be any thickness from a thin coating, as defined above, up to 50% of the thickness of the primary structural element, the cladding 306.

In an alternative embodiment, not shown, the primary structural element is one of the barriers (either the cladding-side barrier 304 or the fuel-side barrier 302). In this embodiment, the cladding may be a thin layer of steel.

Again, the layers of the BEC (i.e., the cladding 306, the cladding-side barrier 304, and the fuel-side barrier 302) are each mechanically or metallurgically bonded to its adjacent layer(s) along the interface with that layer. For example, in a tubular embodiment such as FIG. 4 the layers of the BEC are mechanically or metallurgically bonded together along the perimeter interface between the layers. Depending on the embodiment, the nuclear material 310 may or may not be mechanically or metallurgically bonded to the fuel-side barrier 302 as discussed in greater detail below.

FIG. 4, likewise, illustrates a tubular embodiment of the BEC of FIG. 2, but this time as a fuel element 400 containing nuclear material 410, including but not limited to nuclear fuel. The nuclear material 410 is in the hollow center of the BEC, in contact with the fuel-side barrier 402. The fuel-side barrier 402 is separated from the cladding 406 by the cladding-side barrier 404. The barriers 402, 404, again, may be any thickness from a thin coating, as defined above, up to 50% of the thickness of the primary structural element, the cladding 406.

The nuclear material 410 may be solid, as shown, or may be an annulus of material so that the completed fuel element is hollow in the center. In another embodiment, the fuel element may have a lobed shape or any other cross section to allow space within the center of the fuel element for expansion of the nuclear material 410.

For the purposes of this application, nuclear material includes any material containing an actinide, regardless of whether it can be used as a nuclear fuel. Thus, any nuclear fuel is a nuclear material but, more broadly, any materials containing a trace amount or more of U, Th, Am, Np, and/or Pu are nuclear materials. Other examples of nuclear materials include spent fuel, depleted uranium, yellowcake, uranium dioxide, metallic uranium, metallic uranium with zirconium and/or plutonium, metallic uranium with molybdenum and/or plutonium, thorium dioxide, thorianite, uranium chloride salts such as salts containing uranium tetrachloride and/or uranium trichloride, and uranium fluoride salts.

Nuclear fuel, on the other hand, includes any fissionable material. Fissionable material includes any nuclide capable of undergoing fission when exposed to low-energy thermal neutrons or high-energy neutrons. Furthermore, fissionable material includes any fissile material, any fertile material or combination of fissile and fertile materials. This includes known metallic, oxide, and mixed-oxide forms of nuclear fuel. A fissionable material may contain a metal and/or metal alloy. In one embodiment, the fuel may be a metal fuel. It can be appreciated that metal fuel may offer relatively high heavy metal loadings and excellent neutron economy, which is desirable for breed-and-burn process of a nuclear fission reactor. Depending on the application, fuel may include at least one element chosen from U, Th, Am, Np, and Pu. In one embodiment, the fuel may include at least about 90 wt.% U--e.g., at least 95 wt.%, 98 wt.%, 99 wt.%, 99.5 wt.%, 99.9 wt.%, 99.99 wt.%, or higher of U. The fuel may further include a refractory or high temperature capable material, which may include at least one element chosen from Nb, Mo, Ta, W, Re, Zr, V, Ti, Cr, Ru, Rh, Os, and Ir. In one embodiment, the fuel may include additional burnable poisons, such as boron, gadolinium, erbium, or indium. In addition, a metal fuel may be alloyed with about 3 wt.% to about 10 wt.% zirconium to dimensionally stabilize the fuel during irradiation.

Examples of reactive environments or materials from which the nuclear material is separated from includes reactor coolants such as Na, NaK, supercritical CO₂, lead, and lead bismuth eutectic and NaCl—MgCl₂.

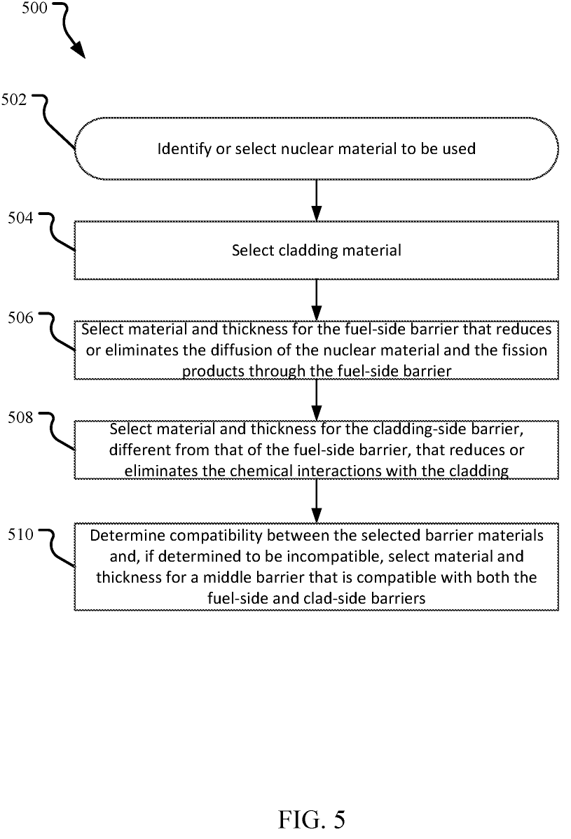

FIG. 5 illustrates an embodiment of a method for selecting the barrier layer materials for an FCCI-resistant BEC and fuel element. In the embodiment shown, the method 500 begins with an identification of the nuclear material to be held by the fuel element in a nuclear material identification operation 502. The nuclear material may be selected from any known material or the range of options may be limited to several materials or only one material due to availability or other constraints. A list of some possible nuclear materials has been provided above.

The cladding material is also determined in a cladding identification operation 504. The cladding material may be determined based on one or more factors such as the strength requirements, thickness requirements, neutronics requirements, availability, cost, corrosion resistance to the external environment, manufacturability, and longevity to name but a few. A list of some possible cladding materials has been provided above.

Regardless of the cladding material selected, it will have certain chemical interaction characteristics relative to the nuclear material. These characteristics will determine to what extent the FCCI will damage the cladding material if it were in direct contact with the selected nuclear material.

With the cladding material and nuclear material known, a fuel-side barrier material may be selected in a fuel-side barrier material selection operation 506. In this operation 506, the fuel-side barrier material is selected that reduces or eliminates the diffusion of the nuclear material and the fission products through the fuel-side barrier, relative the cladding material. That is, the fuel-side barrier material will be selected that has better chemical interaction characteristics with the nuclear material than the selected cladding material. In an embodiment, for example, the fuel-side barrier material has improved resistance to interdiffusion of lanthanide fission products than the cladding material has. A barrier thickness may also be determined as part of this operation 506.

This selection operation 506 takes into account the anticipated thermal, physical (e.g., pressure and configuration), and neutronic environment that the final nuclear fuel element will be exposed to during reactor operation. For example, in an embodiment, a primary functional requirement of FCCI barriers is to withstand design lifetimes (40– 60 years) at elevated temperatures (550 – 625° C.) with minimal interaction with fuel, fission products, and cladding components.

A cladding-side barrier material is also selected in a cladding-side barrier material selection operation 508. In this operation 508, a cladding-side barrier material, that is different in base material from the fuel-side barrier material, is selected that reduces or eliminates detrimental chemical interactions with the cladding material, relative to the selected fuel-side barrier material. That is, the selected cladding-side barrier material has some better chemical interaction characteristic with the cladding than the fuel-side barrier material has. For example, the selected cladding-side material may have improved resistance to interdiffusion of one or more chemical elements from the cladding material than the fuel-side barrier material. As another example, in an embodiment, cladding material is a carbon-containing steel and the selected cladding-side barrier material demonstrates less decarburization of the cladding material than the fuel-side barrier material. Other chemical interaction characteristics are known including the propensity to alloy with components in the cladding material. In addition, in an embodiment the cladding-side barrier material is also selected for its compatibility with the fuel-side barrier material. A cladding-side barrier thickness may also be determined as part of this operation 508.

For example, one detrimental chemical interaction observed with carbon containing steels is decarburization of the steel over time in a nuclear environment. A cladding-side barrier material, that is different in base material from the fuel-side barrier material, may be selected that has been proven to reduce the amount of decarburization observed when under the anticipated thermal, physical (e.g., pressure and configuration), and neutronic environment that the final nuclear fuel element will be exposed to during reactor operation. For example, in a particular embodiment, each of the barrier materials is also selected to impede diffusion of mobile species of concern.

A compatibility check is then performed to verify the compatibility of the two selected barrier materials in an analysis operation 510. This operation 510 determines the compatibility of the two selected barrier materials under the expected conditions of operation. If it is determined that the cladding-side barrier material and the fuel-side barrier material are not sufficiently compatible, then a three- or more-layer barrier embodiment may be investigated. In an embodiment, this may include selecting a material and thickness for a middle barrier that is compatible with both the fuel-side and clad-side barriers. Additional barrier layers may be considered as appropriate with each layer material, thickness, and application being selected and applied as appropriate for the adjacent barriers, fuel, and/or cladding.

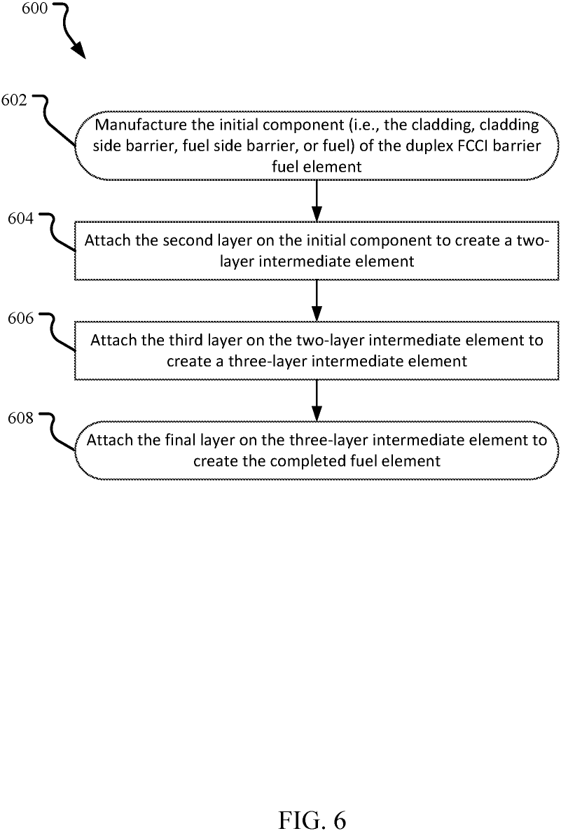

FIG. 6 illustrates at a high-level an embodiment of a method for manufacturing a FCCI-resistant fuel element. Given a selected set of materials and thicknesses for each of the four or more layers, the method 600 manufactures a final fuel element.

In the embodiment shown, the method 600 starts with the fabrication of the initial component layer of the fuel element in a manufacturing operation 602. This may be any of the layers previously discussed, i.e., the cladding, the cladding-side barrier, the fuel-side barrier or the fuel. This initial component is fabricated in the manufacturing operation 602 as a stand-alone component of a desired shape to which the other layers may be later attached.

For example, in an embodiment in which the cladding is an HT9 steel, the manufacturing operation 602 may include conventional forging of the HT9 steel and drawing it into a tube or sheet. Likewise, in an embodiment in which the cladding-side barrier is the initial component, manufacturing operation 602 may include conventional forging of the cladding-side barrier material and drawing it into a tube or sheet to create the stand-alone component. Three-dimensional printing may also be used to fabricate the initial component.

After the initial component is manufactured, a second layer attachment operation 604 is performing in which the second layer is attached to the initial component. In the attachment operation 604, the first and second layers are mechanically or metallurgically bonded at the interface of the layers. For example, in a tubular embodiment the first and second layers are mechanically or metallurgically bonded together along the perimeter interface of the two layers. As a specific example, a tube of HT9 may be drawn and then the inner surface may be coated with a cladding-side barrier material selected from the list provided above using any one of techniques described below.

The attachment technique used will be informed by the types of materials being attached. Examples of attachment techniques are discussed in greater detail below. The result is a two-layer intermediate component. For a duplex barrier fuel element, the two-layer intermediate component is one of a) a cladding and cladding-side barrier intermediate, b) a cladding-side barrier and fuel-side barrier intermediate, or c) a fuel-side barrier and nuclear material intermediate depending on what the initial component was. As part of this operation 604 the second layer may first be fabricated and then attached or the attachment and fabrication may be simultaneous as when the second layer is deposited on the initial component.

A third layer attachment operation 606 is then performed to attach the third layer to the two-layer intermediate component. In the third layer attachment operation 606, the third layer is mechanically or metallurgically bonded to one of the two layers of the two-layer intermediate component. For example, in a tubular embodiment the second and third layers are mechanically or metallurgically bonded together along the perimeter interface of the two layers. This creates a three-layer intermediate component. For a duplex barrier fuel element, the three-layer intermediate component will either be a BEC or a cladding-side barrier/fuel-side barrier/nuclear material intermediate, again, depending on what the initial component was and the order in which the layers were attached. Again, as part of this operation 606 the third layer may first be fabricated and then attached or the attachment and fabrication may be simultaneous as when the third layer is deposited on the two-layer intermediate component.

As a specific example, a tube of HT9 may be drawn and then coated with a cladding-side barrier material, then a tube of the fuel-side barrier material may be manufactured and inserted into the HT9/cladding-side barrier intermediate component. The three-layer intermediate component may then be hot or cold drawn to improve the bond between the cladding-side barrier and the fuel-side barrier.

The duplex FCCI barrier fuel element is then completed in final attachment operation 608. In this operation the final layer, which will either be the cladding or the nuclear material, is combined with the three-layer intermediate component to form the final fuel element. This may include some final processing or bonding operations to complete the attachment of all of the layers into the final product. For example, in an embodiment the final attachment operation 608 includes a process that provides a final metallurgical bond between one or more layers that were previously mechanically bonded in an earlier operation.

The final attachment operation 608 may also include the attachment of any external fittings needed for use. For example, the final attachment operation 608 may include applying one or more end caps onto the fuel element. Any additional hardware or components may also be provided as part of this operation 608.

Intermediate anneals may be performed under vacuum or reducing conditions as desired as part of the any of the operations of the method 600. Final heat treatment including normalization and tempering may also be performed as desired.

As mentioned above, the initial component may be fabricated in the manufacturing operation 602 in any conventional fashion. The later attachment operations 604, 606, 608 include any suitable technique for creating the respective layer of the selected material and attaching it to the initial or intermediate component. In an embodiment, the cladding and barriers are each hermetic to prevent easy migration of gaseous fission products, with no wall-through defects or cracks created during manufacture. Furthermore, the use of mechanical or metallurgical bonds between the layers of the BEC results in good thermal conductivity without the use of thermal bonding materials such as liquid sodium. Examples of suitable techniques, depending on the materials in question, include separate, conventional fabrication, for example, cold drawing or three-dimensional printing, of the layer to be attached and simple mechanical bonding such as by insertion, rolling, press fitting, swaging, co-drawing, co-extrusion, or pilgering (cold or hot). Mechanical attachment techniques may include elevated temperatures (e.g., hot pilgering or hot isostatic press) to assist in the creation of a good attachment between the layers and layers without any cracks or other deformities.

In some cases, using differences in thermal expansion during construction of the fuel element may be possible as part of the final attachment operation 608. In this way, barriers and or nuclear material may be ‘slid’ into the BEC and reach a desired state once predetermined thermal conditions are met, such as steady state reactor operating temperature, refueling temperature, or the temperature at which the fuel is shipped after manufacturing. Thus, although the embodiments shown in FIGS. 1-4 and 7-10 illustrate the various layers as entirely bonded together along their surfaces of contact, at different points during the manufacturing process this may not be the case, especially when the layers are mechanically bonded together. In addition, although ideal, such a perfect bonding at all points along interfacing surfaces may not be achievable in reality.

Additionally, the barriers may be created and attached by depositing the layer’s material onto the target component. This may be achieved by, for example, electroplating; chemical vapor deposition (CVD) specifically, by metal organic chemical vapor deposition (MOCVD); or physical vapor deposition (PVD) specifically, thermal evaporation, sputtering, pulsed laser deposition (PLD), cathodic arc, and electrospark deposition (ESD). Each of these attachment techniques are known in the art.

In some embodiments the nuclear material need not be attached to the fuel-side barrier, but rather can just be contained within a container formed, at least in part, by the BEC. For example, pelletized nuclear fuel may simply be loaded into a BEC in the form of a closed tube or a vessel of some other shape.

Alternatively, metallurgical bonds between one or more layers may be created as part of the method 600, for example by hot pressing (e.g., hot isostatic pressing). For example, in an embodiment a three-layer intermediate component consisting of a tubular billet of the cladding, cladding-side barrier and fuel-side barrier having a center void may be created by either mechanical attachment of separate tubes of material, deposition of materials, or a combination of both. The three-layer intermediate component may then be hot pressed using constant pressure (hot isostatic pressing or HIP) to create a metallurgical bond between the layers of the three-layer intermediate. The three-layer intermediate component may then be extruded or pilgered (or a combination of both), followed by cold-rolling or cold-drawing into final shape.

In an alternative embodiment, the first step of the process can also be hot extrusion. For example, a hot extrusion followed by HIP, and HIP followed by hot extrusion is an alternative method for achieving the metallurgical bonds.

For example, a BEC may be manufactured in this way by assembling a tube of cladding material, cladding-side barrier material and fuel-side barrier material and then hot pressing them, followed by an extrusion and cold-rolling or -drawing into the final form factor for the BEC. In an alternative metallurgical bond embodiment, an intermediate component may be extruded or pilgered (or a combination of both) first and then hot pressed to provide the metallurgical bond. The intermediate component may then be processed into a final from factor or the form factor needed for subsequent processing steps.

Table 1, below, illustrates some of the possible manufacturing method embodiments for a duplex FCCI barrier fuel element including the different order of attachment and the different possible attachment techniques. The various permutations of the method of FIG. 6 include, for example, an annular fuel coated by PVD (both barriers) with the cladding swaged over the fuel/fuel-side barrier/cladding-side barrier intermediate. The method 600 also includes embodiments in which the fuel may be extruded, cast, pilgered, or tube welded.

Specifically, the method of FIG. 6 includes embodiments in which the barriers and the cladding may be co-extruded either as a completion of the third layer attachment operation 606 or as part of the final attachment operation 608. For example, the third layer attachment operation 606 may include co-extruding or pilgering all layers of the BEC into its final form factor prior to the final assembly with nuclear material. Likewise, the final attachment operation 608 may include a step of co-extruding or pilgering all of the layers, including the nuclear material, into a final form of the fuel element.

As another example embodiment, the method 600 includes cold-drawing a “thin” fuel-side barrier, PVD coat the cladding-side barrier on its exterior, and then insert duplex barrier inside of cladding and performing a cold sinking/drawing operation to mechanically bond the layers.

In yet another embodiment (not shown) of the method 600, the BEC or the completed fuel element may be created as part of a single fabrication operation in which the initial fabrication operation 602 and the attachment operations 604, 606, 608 are performed concurrently, for example by three-dimensionally printing all layers at the same time.

Casting techniques may also be used to create the fuel. In some cases, casting may take place directly within the fuel pin internal to the liner and or cladding. Casting may also be performed to provide internal structure to either collect or transport products of fission.

In addition to the duplex barrier embodiments shown above, three FCCI barriers may also be useful in some circumstances. Three barrier, or triplex barrier, embodiments involve providing an intermediate layer between the cladding-side barrier and the fuel-side barrier to reduce the interactions between those two barriers, to provide a better attachment between those two layers, or to provide additional protection against the interdiffusion of nuclear material or fission products towards the external environment. Otherwise, the triplex barrier embodiments are similar to the duplex barrier embodiments in that each barrier is of a different base material than any adj acent barrier or barriers. The cladding may be the primary structural element or, alternatively, one of the three barriers may be the primary structural element.

TABLE 1

Duplex FCCI Fuel Element Manufacturing Embodiments

| | | | | | | |
|---|---|---|---|---|---|---|
| Initial Component | Two-layer Intermediate Component | Second Layer Attachment Technique | Three-layer Intermediate Component | Third Layer Attachment Technique | Final Product | Final Layer Attachment Technique |
| Cladding | Cladding and Cladding-Side Barrier | Fabrication and mechanical assembly or attachment, Electroplating, CVD or PVD | BEC | Fabrication and mechanical assembly, Electroplating, CVD or PVD | Fuel Element | Fabrication and mechanical assembly or attachment |
| Cladding-side Barrier | Cladding and Cladding-side Barrier | Fabrication and mechanical assembly or attachment | BEC | Fabrication and mechanical assembly, Electroplating, CVD or PVD | Fuel Element | Fabrication and mechanical assembly or attachment |
| Fuel-side Barrier | Cladding-side Barrier and Fuel-side Barrier | Fabrication and mechanical assembly or attachment, Electroplating, CVD or PVD | BEC | Fabrication and mechanical assembly | Fuel Element | Fabrication and mechanical assembly or attachment |
| Fuel-side Barrier | Fuel and Fuel-side Barrier | Fabrication and mechanical assembly or attachment | Fuel, Fuel-side Barrier and Cladding-side Barrier component | Fabrication and mechanical assembly, Electroplating, CVD or PVD | Fuel Element | Fabrication and mechanical assembly or attachment |
| Fuel | Fuel-side Barrier | Fabrication and mechanical assembly or attachment, Electroplating, CVD or PVD | Fuel, Fuel-side Barrier and Cladding-side Barrier component | Fabrication and mechanical assembly, Electroplating, CVD or PVD | Fuel Element | Fabrication and mechanical assembly or attachment |

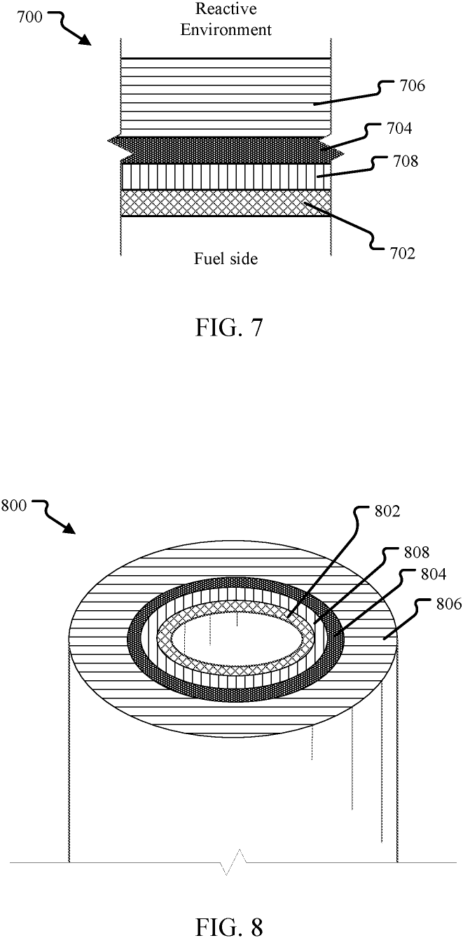

FIGS. 7-10 illustrate a triplex barrier embodiment for a BEC and FCCI-resistant fuel element. FIGS. 7-10 mirror the presentation of the duplex barrier embodiments shown in FIGS. 1-4.

FIG. 7 illustrates a cut away view of a linear section, or “wall element”, of BEC having a triplex FCCI barrier. Again, the BEC 700 may be part of any equipment, vessel, or component that separates nuclear fuel from an external environment. The BEC 700 consists of three FCCI barriers 702, 704, 708 and a cladding 706. The fuel-side barrier 102 separates the fuel, or the storage area where the fuel will be placed if the fuel has not been provided yet, from the intermediate FCCI barrier 708. The intermediate FCCI barrier 708 is between the fuel-side barrier 702 and the cladding-side barrier 704. The cladding-side barrier 704 is between the intermediate barrier 708 and the cladding 706. The cladding 106 is in contact with the external environment on one surface and the cladding-side barrier 104 on the opposite surface.

The FCCI barriers 702, 704, 708 may be any of the materials described above with reference to the barriers of FIGS. 1-4. However, in an embodiment no two adjacent barriers may be of the same base material. That is, in this embodiment the fuel-side barrier 702 and cladding-side barrier 704 may be of the same base material, but the intermediate barrier 708 is of a material that is different from both the fuel-side barrier 702 and cladding-side barriers 704. In all other respects, the BEC 700 is the same as described above with reference to FIG. 1.

FIG. 8 illustrates a tubular embodiment of the triplex BEC of FIG. 7. In the embodiment shown, the wall element 800 is in the form of a tube with an interior surface and an exterior surface, the fuel-side barrier 802 forming the interior surface of the tube and the cladding 806 of steel forming the exterior surface of the tube. Sandwiched between the fuel-side barrier 802 and the cladding-side barrier 804 in the intermediate FCCI barrier 808. The fuel storage region is in the center region of the tube. Fuel, when placed within the tube, will be protected from the reactive external environment at the same time the cladding 806 is separated and protected from chemical interactions with the fuel. Again, the general term wall element is used to acknowledge that a tube or other shape of container may have multiple different walls or sections of a wall, not all of which consist of BEC.

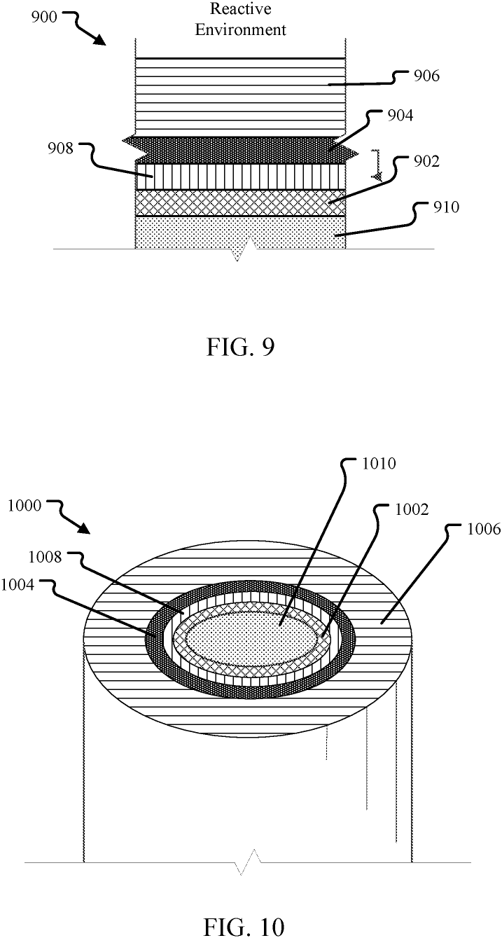

FIG. 9 illustrates the triplex barrier wall element of FIG. 7, but this time as a fuel element with nuclear material 910, including but not limited to nuclear fuel, in contact with the fuel-side barrier 902. The fuel-side barrier 902 is separated from the cladding-side barrier 904 by the intermediate barrier 908. The barriers 902, 904, 908, again, may be any thickness from a thin coating up to 50% of the thickness of the primary structural element, the cladding 906.

FIG. 10, likewise, illustrates a tubular embodiment of the triplex BEC of FIG. 8, but this time as a fuel element 1000 containing nuclear material 1010, including but not limited to nuclear fuel. The nuclear material 1010 is in the hollow center of the BEC, in contact with the fuel-side barrier 1002. The fuel-side barrier 1002 is separated from the cladding-side barrier 1004 by an intermediate barrier 1008 of a different material. The barriers 1002, 1004, 1008, again, may be any thickness from a thin coating up to 50% of the thickness of the primary structural element, the cladding 1006. In all other respects, the BEC 900 is the same as described above with reference to FIG. 3.

The nuclear material 1010 may be solid, as shown, or may be an annulus of material so that the completed fuel element is hollow in the center. In another embodiment, the fuel element may have a lobed or any other cross section to allow space within the interior of the fuel element for expansion of the nuclear material 1010. In all other respects, the fuel element 1000 is the same as described above with reference to FIG. 4.

The triplex fuel elements and BECs of FIGS. 7-10 may be manufactured using methods similar to those of FIGS. 5 and 6. The material selection method of FIG. 5 is modified to include an additional operation for the selection of the intermediate barrier material. The operation includes selecting a material that is chemically compatible with the cladding-side barrier material and the fuel-side barrier material. In an embodiment, the intermediate barrier material has one or more better chemical interaction characteristics with each of its adjacent barriers than those barriers do with each other.

Likewise, the manufacturing method of FIG. 6 is modified to include an additional layer attachment operation. Of course, addition of the third barrier adds one more component to the matrix meaning that there are many different, possible orders of fabricating and attaching the various layers.

### Fuel Elements and Fuel Assemblies

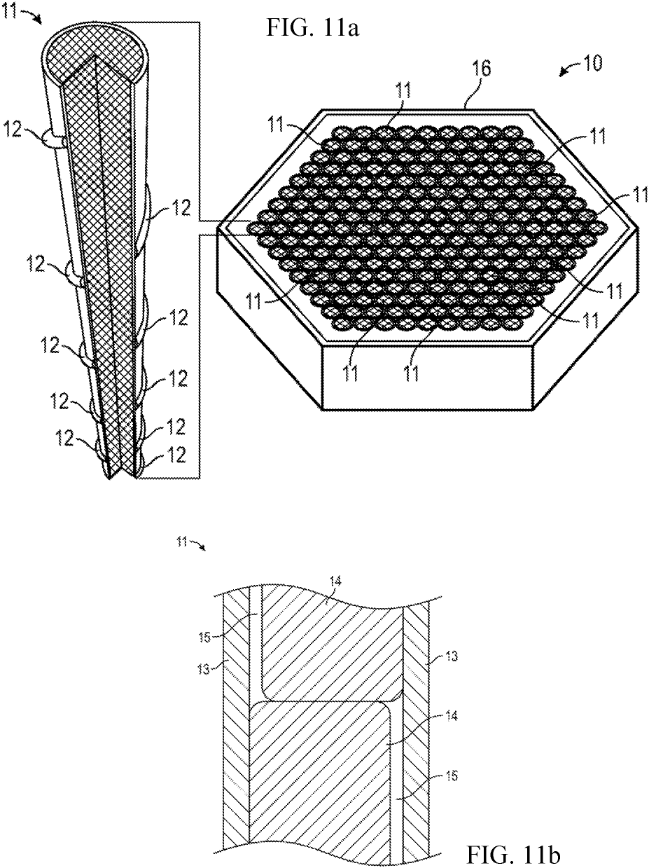

FIG. 11a provides a partial illustration of a nuclear fuel assembly 10 utilizing one or more of the duplex or triplex BECs described above. The fuel assembly 10, as shown, includes a number of individual fuel elements (or “fuel rods” or “fuel pins”) 11 held within a containment structure 16.

FIG. 11b provides a partial illustration of a fuel element 11 in accordance with one embodiment. As shown in this embodiment, the fuel element includes a duplex or triplex BEC 13, a fuel 14, and, in some instances, at least one gap 15. Although illustrated as a single element, the duplex or triplex BEC 13 is composed of, entirely or at least in part, of the two barrier or three barrier claddings described above.

A fuel is sealed within a cavity created by the exterior BEC 13. In some instances, the multiple fuel materials may be stacked axially as shown in FIG. 11b, but this need not be the case. For example, a fuel element may contain only one fuel material. In one embodiment, gap(s) 15 may be present between the fuel material and the BEC, though gap(s) need not be present. In one embodiment, the gap is filled with a pressurized atmosphere, such as a pressurized helium atmosphere.

In one embodiment, individual fuel elements 11 may have a thin wire 12 from about 0.8 mm diameter to about 1.6 mm diameter helically wrapped around the circumference of the cladding tubing to provide coolant space and mechanical separation of individual fuel elements 11 within the housing of the fuel assemblies 10 (that also serve as the coolant duct). In one embodiment, the duplex or triplex BEC 13, and/or wire wrap 12 may be fabricated from ferritic-martensitic steel because of its irradiation performance as indicated by a body of empirical data.

The fuel element may have any geometry, both externally and for the internal fuel storage region. For example, in some embodiments shown above, the fuel element is cylindrical and may take the form of a cylindrical rod. In addition, some prismatoid geometries for fuel elements may be particularly efficient. For example, the fuel elements may be right, oblique, or truncated prisms having three or more sides and any polygonal shape for the base. Hexagonal prisms, rectangular prisms, square prisms and triangular prisms are all potentially efficient shapes for packing a fuel assembly.

The fuel elements and fuel assembly may be a part of a power generating reactor, which is a part of a nuclear power plant. Heat generated by the nuclear reaction is used to heat a coolant in contact with the exterior of the fuel elements. This heat is then removed and used to drive turbines or other equipment for the beneficial harvesting of power from the removed heat.

Notwithstanding the appended claims, the disclosure is also defined by the following clauses:
1. A method for manufacturing an FCCI-resistant fuel element comprising:
   identifying a nuclear material for use in a fuel element as a fuel component;
   fabricating an initial component selected from a cladding, a cladding-side barrier, a fuel-side barrier, and the fuel component;
   attaching a second layer to the initial component to create a two-layer intermediate element;
   attaching a third layer to the two-layer intermediate element to create a three-layer intermediate element; and
   attaching a final layer on the three-layer intermediate element to create the fuel element, the fuel element having the cladding, the cladding-side barrier, the fuel-side barrier, and the fuel component in which the cladding-side barrier is between the cladding and the fuel-side barrier and the fuel-side barrier is between the cladding-side barrier and the fuel component.
2. The method of clause 1, further comprising:
   selecting a cladding material for use as the cladding of the fuel element, the nuclear material exhibiting a first interdiffusion distance into the cladding material when the cladding material is placed in contact with the nuclear material for 2 months and held at 650° C.; and
   selecting a fuel-side barrier material for use as the fuel-side barrier of the fuel element, the nuclear material exhibiting a second interdiffusion distance into the fuel-side barrier material when the fuel-side material is placed in contact with the nuclear material for 2 months and held at 650° C., the second interdiffusion distance being less than the first interdiffusion distance.
3. The method of clause 2, wherein at least one chemical element in the fuel-side barrier material exhibits a third interdiffusion distance into the cladding material when placed in contact with the cladding material for 2 months and held at 650° C.; and
   wherein at least one chemical element in the cladding-side barrier material exhibits a fourth interdiffusion distance into the cladding material when placed in contact with the cladding material for 2 months and held at 650° C., the third interdiffusion distance being greater than the fourth interdiffusion distance.
4. The method of any of clauses 1-3, wherein the initial component is the cladding, the second layer is the cladding-side barrier, the third layer is the fuel-side barrier, and the final layer is the fuel component.
5. The method of any of clauses 1-4, wherein the initial component is the cladding-side barrier, the second layer is the cladding, the third layer is the fuel-side barrier, and the final layer is the fuel component.
6. The method of any of clauses 1-5, wherein the initial component is the fuel-side barrier, the second layer is the cladding-side barrier, the third layer is the cladding, and the final layer is the fuel component.
7. The method of any of clauses 1-6, wherein the initial component is the fuel-side barrier, the second layer is the fuel component, the third layer is the cladding-side barrier, and the final layer is the cladding.
8. The method of any of clauses 1-7, wherein the initial component is the fuel component, the second layer is the fuel-side barrier, the third layer is the cladding-side barrier, and the final layer is the cladding.
9. The method of any of clauses 2-8, wherein the cladding-side barrier is attached to the cladding by one of mechanical attachment, electroplating, chemical vapor deposition or physical vapor deposition of the cladding-side barrier material onto the cladding.
10. The method of any of clauses 2-8, wherein the fuel-side barrier is attached to the cladding-side barrier by one of mechanical attachment, electroplating, chemical vapor deposition or physical vapor deposition of the cladding-side barrier material onto the fuel-side barrier.
11. The method of any of clauses 2-8, wherein the cladding-side barrier is attached to the fuel-side barrier by one of mechanical attachment, electroplating, chemical vapor deposition or physical vapor deposition of the fuel-side barrier material onto the cladding-side barrier.
12. The method of any of clauses 2-8, wherein the fuel-side barrier is attached to the fuel component by mechanical attachment, electroplating, chemical vapor deposition or physical vapor deposition of the fuel-side material onto the fuel component.
13. The method of any of clauses 2-8, wherein the cladding-side barrier material is selected from Nb, Mo, Ta, W, Re, Zr, V, Ti, Cr, Ru, Rh, Os, Ir, Sc, Fe, Ni, an alloy of any of the preceding materials, ceramic TiN, ceramic ZrN, ceramic VN, ceramic TiC, ceramic ZrC, or ceramic VC.
14. The method of any of clauses 2-8, wherein the fuel-side barrier material is selected from Nb, Mo, Ta, W, Re, Zr, V, Ti, Cr, Ru, Rh, Os, Ir, Sc, Fe, Ni, an alloy of any of the preceding materials, ceramic TiN, ceramic ZrN, ceramic VN, ceramic TiC, ceramic ZrC, or ceramic VC.
15. The method of any of clauses 9-14 wherein the attaching is by metal organic chemical vapor deposition (MOCVD); thermal evaporation, sputtering, pulsed laser deposition (PLD), cathodic arc, or electrospark deposition (ESD).
16. The method of any of clauses 1-15, wherein the fuel element consists of:
   the cladding, the cladding-side barrier, the fuel-side barrier, and the fuel component in which the cladding-side barrier is between the cladding and the fuel-side barrier and the fuel-side barrier is between the cladding-side barrier and the fuel component.
17. The method of any of clauses 1-16 wherein the initial component, the second layer, and the third layer are co-extruded.
18. The method of any of clauses 2-17, wherein the cladding material has a base chemical element that is greater than 50 wt.% of the cladding material and the at least one chemical element in the cladding material is the base chemical element of the cladding material.
19. The method of any of clauses 2-18, wherein the fuel-side barrier material has a base chemical element that is greater than 50 wt.% of the fuel-side barrier material and the at least one chemical element in the fuel-side barrier material is the base chemical element of the fuel-side barrier material.
20. The method of any of clauses 2-19, wherein the cladding-side barrier material has a base chemical element that is greater than 50 wt.% of the cladding-side barrier material and the at least one chemical element in the cladding-side barrier material is the base chemical element of the cladding-side barrier material.
21. The method of any of clauses 2-17, wherein the cladding material has a base chemical element that is greater than 50 wt.% of the cladding material and the at least one chemical element in the cladding material is different from the base chemical element of the cladding material.
22. The method of any of clauses 2-18, wherein the fuel-side barrier material has a base chemical element that is greater than 50 wt.% of the fuel-side barrier material and the at least one chemical element in the fuel-side barrier material is different from the base chemical element of the fuel-side barrier material.
23. The method of any of clauses 2-19, wherein the cladding-side barrier material has a base chemical element that is greater than 50 wt.% of the cladding-side barrier material and the at least one chemical element in the cladding-side barrier material is different from the base chemical element of the cladding-side barrier material.
24. A duplex barrier-equipped cladding for holding nuclear material comprising:
   a cladding made of a cladding material selected from a stainless steel, an FeCrAl alloys, a HT9 steel, a oxide-dispersion strengthened steel, a T91 steel, a T92 steel, a 316 steel, a 304 steel, an APMT steel, an Alloy 33 steel, molybdenum, a molybdenum alloy, zirconium, a zirconium alloy, niobium, a niobium alloy, a zirconium-niobium alloys, nickel or a nickel alloy;
   a fuel-side barrier; and
   a cladding-side barrier between the fuel-side barrier and the cladding;
   wherein the fuel-side barrier is a first material and the cladding-side barrier is a second material having a different base chemical element than that of the first material.
25. The duplex barrier-equipped cladding for holding nuclear material of clause 24, wherein the first material exhibits less interdiffusion of uranium than the second material when placed in contact for 2 months and held at 650° C.
26. The duplex barrier-equipped cladding for holding nuclear material of clause 24, wherein the second material exhibits less interdiffusion of the first material than the cladding material when placed in contact for 2 months and held at 650° C.
27. The duplex barrier-equipped cladding for holding nuclear material of any of clauses 24 and 25, wherein the first material is selected from Nb, Mo, Ta, W, Re, Zr, V, Ti, Cr, Ru, Rh, Os, Ir, Sc, Fe, Ni, an alloy of any of the preceding materials, ceramic TiN, ceramic ZrN, ceramic VN, ceramic TiC, ceramic ZrC, or ceramic VC and the fuel-side barrier is from 1.0 to 150.0 µm thick.
28. The duplex barrier-equipped cladding for holding nuclear material of any of clauses 24-26, wherein the second material is selected from Nb, Mo, Ta, W, Re, Zr, V, Ti, Cr, Ru, Rh, Os, Ir, Sc, Fe, Ni, an alloy of any of the preceding materials, ceramic TiN, ceramic ZrN, ceramic VN, ceramic TiC, ceramic ZrC, or ceramic VC and the cladding-side barrier is from 1.0 to 150.0 µm thick.
29. A triplex barrier-equipped cladding for holding nuclear material comprising:
   a cladding made of a cladding material selected from a stainless steel, an FeCrAl alloys, a HT9 steel, a oxide-dispersion strengthened steel, a T91 steel, a T92 steel, a 316 steel, a 304 steel, an APMT steel, an Alloy 33 steel, molybdenum, a molybdenum alloy, zirconium, a zirconium alloy, niobium, a niobium alloy, a zirconium-niobium alloys, nickel or a nickel alloy;
   a fuel-side FCCI barrier;
   a cladding-side FCCI barrier between the fuel-side FCCI barrier and the cladding; and
   an intermediate FCCI barrier between the cladding-side FCCI barrier and the fuel-side FCCI barrier;
   wherein the fuel-side FCCI barrier is a first material, the intermediate FCCI barrier is a second material of a different base material from that of the first material; and the cladding-side FCCI barrier is a third material of a different base chemical element from that of the second material.
30. The triplex barrier-equipped cladding for holding nuclear material of clause 29, wherein the first material exhibits less interdiffusion of uranium than the second material when placed in contact for 2 months and held at 650° C.
31. The triplex barrier-equipped cladding for holding nuclear material of clause 29, wherein the second material exhibits less interdiffusion of the first material than the third material when placed in contact for 2 months and held at 650° C.
32. The triplex barrier-equipped cladding for holding nuclear material of clause 29, wherein the third material exhibits less interdiffusion of the second material than the cladding material when placed in contact for 2 months and held at 650° C.
33. The triplex barrier-equipped cladding for holding nuclear material of any of clauses 29-32, wherein the first material is selected from Nb, Mo, Ta, W, Re, Zr, V, Ti, Cr, Ru, Rh, Os, Ir, Sc, Fe, Ni, an alloy of any of the preceding materials, ceramic TiN, ceramic ZrN, ceramic VN, ceramic TiC, ceramic ZrC, or ceramic VC.
34. The triplex barrier-equipped cladding for holding nuclear material of clause 29, wherein the second material is selected from Nb, Mo, Ta, W, Re, Zr, V, Ti, Cr, Ru, Rh, Os, Ir, Sc, Fe, Ni, an alloy of any of the preceding materials, ceramic TiN, ceramic ZrN, ceramic VN, ceramic TiC, ceramic ZrC, or ceramic VC.
35. The triplex barrier-equipped cladding for holding nuclear material of clause 34, wherein the third material is selected from Nb, Mo, Ta, W, Re, Zr, V, Ti, Cr, Ru, Rh, Os, Ir, Sc, Fe, Ni, an alloy of any of the preceding materials, ceramic TiN, ceramic ZrN, ceramic VN, ceramic TiC, ceramic ZrC, or ceramic VC.
36. The triplex barrier-equipped cladding for holding nuclear material of any of clauses 29-32 and 35 wherein each of the fuel-side barrier, the cladding-side barrier, and the intermediate FCCI barrier is from 1.0 to 150.0 µm thick.
37. A method for manufacturing an FCCI-resistant fuel element comprising:
   identifying a nuclear material for use in a fuel element as a fuel component;
   fabricating an initial component selected from a cladding, a cladding-side barrier, a fuel-side barrier, and the fuel component;
   attaching a second layer to the initial component to create a two-layer intermediate element;
   attaching a third layer to the two-layer intermediate element to create a three-layer intermediate element; and
   attaching a final layer on the three-layer intermediate element to create the fuel element, the fuel element having the cladding, the cladding-side barrier, the fuel-side barrier, and the fuel component in which the cladding-side barrier is between the cladding and the fuel-side barrier and the fuel-side barrier is between the cladding-side barrier and the fuel component.
38. The method of clause 37, further comprising:
   selecting a cladding material for use as the cladding of the fuel element, the cladding material having a first chemical interaction characteristic with the nuclear material;
   selecting a fuel-side barrier material for use as the fuel-side barrier of the fuel element having a first chemical interaction characteristic with the nuclear material better than that of the cladding material and second chemical interaction characteristic with the cladding material; and
   selecting a cladding-side barrier material for use as the cladding-side barrier of the fuel element having a second chemical interaction characteristic with the cladding material better than that of the fuel-side barrier material.
39. The method of clause 37, wherein the initial component is the cladding, the second layer is the cladding-side barrier, the third layer is the fuel-side barrier, and the final layer is the fuel component.
40. The method of clause 37, wherein the initial component is the cladding-side barrier, the second layer is the cladding, the third layer is the fuel-side barrier, and the final layer is the fuel component.
41. The method of clause 37, wherein the initial component is the fuel-side barrier, the second layer is the cladding-side barrier, the third layer is the cladding, and the final layer is the fuel component.
42. The method of clause 37, wherein the initial component is the fuel-side barrier, the second layer is the fuel component, the third layer is the cladding-side barrier, and the final layer is the cladding.
43. The method of clause 37, wherein the initial component is the fuel component, the second layer is the fuel-side barrier, the third layer is the cladding-side barrier, and the final layer is the cladding.
44. The method of clause 37, wherein the cladding-side barrier is attached to the cladding by one of mechanical attachment, electroplating, chemical vapor deposition, hot extrusion, hot isostatic pressing, or physical vapor deposition of the cladding-side barrier material onto the cladding.
45. The method of clause 37, wherein the fuel-side barrier is attached to the cladding-side barrier by one of mechanical attachment, electroplating, chemical vapor deposition, hot extrusion, hot isostatic pressing, or physical vapor deposition of the cladding-side barrier material onto the fuel-side barrier.
46. The method of clause 37, wherein the cladding-side barrier is attached to the fuel-side barrier by one of mechanical attachment, electroplating, chemical vapor deposition, hot extrusion, hot isostatic pressing, or physical vapor deposition of the fuel-side barrier material onto the cladding-side barrier.
47. The method of clause 37, wherein the fuel-side barrier is attached to the fuel component by mechanical attachment, electroplating, chemical vapor deposition, hot extrusion, hot isostatic pressing, or physical vapor deposition of the fuel-side material onto the fuel component.
48. The method of clause 37, wherein the cladding-side barrier material is selected from Nb, Mo, Ta, W, Re, Zr, V, Ti, Cr, Ru, Rh, Os, Ir, Sc, Fe, Ni, an alloy of any of the preceding materials, ceramic TiN, ceramic ZrN, ceramic VN, ceramic TiC, ceramic ZrC, or ceramic VC.
49. The method of clause 37, wherein the fuel-side barrier material is selected from Nb, Mo, Ta, W, Re, Zr, V, Ti, Cr, Ru, Rh, Os, Ir, Sc, Fe, Ni, an alloy of any of the preceding materials, ceramic TiN, ceramic ZrN, ceramic VN, ceramic TiC, ceramic ZrC, or ceramic VC.
50. The method of any of clauses 44-49 wherein the attaching is by metal organic chemical vapor deposition (MOCVD); thermal evaporation, hot extrusion, hot isostatic pressing, sputtering, pulsed laser deposition (PLD), cathodic arc, or electrospark deposition (ESD).
51. The method of any of clauses 37-49 wherein the fuel element consists of:
   the cladding, the cladding-side barrier, the fuel-side barrier, and the fuel component in which the cladding-side barrier is between the cladding and the fuel-side barrier and the fuel-side barrier is between the cladding-side barrier and the fuel component.
52. A triplex barrier-equipped cladding for holding nuclear material comprising:
   a cladding made of a cladding material selected from a stainless steel, an FeCrAl alloys, a HT9 steel, a oxide-dispersion strengthened steel, a T91 steel, a T92 steel, a 316 steel, a 304 steel, an APMT steel, an Alloy 33 steel, molybdenum, a molybdenum alloy, zirconium, a zirconium alloy, niobium, a niobium alloy, a zirconium-niobium alloys, nickel or a nickel alloy;
   a fuel-side FCCI barrier;
   a cladding-side FCCI barrier between the fuel-side FCCI barrier and the cladding; and
   an intermediate FCCI barrier between the cladding-side FCCI barrier and the fuel-side FCCI barrier;
   wherein the fuel-side FCCI barrier is made of a first material that has an improved chemical interaction characteristic with the nuclear material compared to that of the cladding material, the intermediate FCCI barrier is a second material of a different base material from that of the first material; and the cladding-side FCCI barrier is a third material of a different base material from that of the second material.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the foregoing specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the systems and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

1-20. (canceled)

21. A nuclear fuel assembly comprising:
a containment structure; and
a plurality of fuel elements held within the containment structure, each of the plurality of fuel elements having an elongated shape and comprising a nuclear material enclosed within a barrier-equipped cladding.

22. The nuclear fuel assembly of claim 21, wherein the barrier-equipped cladding comprises at least a cladding, a cladding-side barrier, a fuel-side barrier.

23. The nuclear fuel assembly of claim 22, wherein the barrier-equipped cladding further comprises an intermediate barrier between the cladding-side barrier and the fuel-side barrier.

24. The nuclear fuel assembly of claim 21, wherein the nuclear material comprises a nuclear fuel.

25. The nuclear fuel assembly of claim 21, wherein the nuclear material is a solid material.

26. The nuclear fuel assembly of claim 25, wherein, in a longitudinal direction of the nuclear fuel assembly, the nuclear material comprises a plurality of solid fuel portions.

27. The nuclear fuel assembly of claim 25, wherein at least one of the plurality of solid fuel portions is separated from the fuel-side barrier by a gap.

28. The nuclear fuel assembly of claim 27, wherein the gap is filled with a pressurized gaz.

29. The nuclear fuel assembly of claim 28, wherein the pressurized gas comprises pressurized helium.

30. The nuclear fuel assembly of claim 21, further comprising a wire helically wrapped around a circumference of each of the plurality of fuel elements.

31. The nuclear fuel assembly of claim 30, wherein the wire has a diameter between 0.8 mm and 1.6 mm.

32. The nuclear fuel assembly of claim 30, wherein the wire comprises ferritic-martensitic steel.

33. The nuclear fuel assembly of claim 21, wherein one or more of the fuel elements have one of a cylindrical shape, am oblique prism shape, and truncated prism shape.

34. The nuclear fuel assembly of claim 21, wherein the containment structures has one of a hexagonal shape, a rectangular shape, a square shape, and a triangular shape.

35. A method of manufacturing nuclear fuel assembly, the method comprising:
preparing a fuel element by:
forming a closed-shaped barrier-equipped cladding by assembling a cladding, a cladding-side barrier, and a fuel-side barrier together; and
adding a nuclear fuel within the closed-shaped barrier-equipped cladding; and stacking a plurality of the fuel elements together within a containment structure.

36. The method of claim 35, wherein adding the nuclear fuel comprises adding a solid nuclear fuel.

37. The method of claim 36, wherein adding the solid nuclear fuel comprises forming a gap between the solid nuclear fuel and the barrier-equipment cladding.

38. The method of claim 37, wherein forming the gap comprises adding a pressurized gas in the gap.
